(19) United States
(12) Patent Application Publication
(10) Pub. No.: US 2017/0227565 A1
(43) Pub. Date: Aug. 10, 2017

(54) METHOD FOR OPERATING AN AUTOMATED ANALYSIS MACHINE

(71) Applicant: Siemens Healthcare Diagnostics Products GmbH, Marburg (DE)

(72) Inventors: Reiner Klingelhoefer, Lahntal (DE); Thorsten Michels, Gross-Gerau (DE); Holger Pufahl, Liederbach (DE); David Solbach, Frankfurt (DE)

(73) Assignee: SIEMENS HEALTHCARE DIAGNOSTICS PRODUCTS GmbH

(21) Appl. No.: 15/429,102

(22) Filed: Feb. 9, 2017

(30) Foreign Application Priority Data
Feb. 10, 2016 (EP) 16154992.8

(51) Int. Cl. G01N 35/10

(52) U.S. Cl. CPC G01N 35/1016

(57) ABSTRACT

The invention relates to a method for transferring a first sample liquid from a first primary vessel into a first target vessel and a second sample liquid from a second primary vessel into a second target vessel with the aid of at least one automated pipetting apparatus comprising a system liquid in an automated analysis machine comprising a control machine.

### CROSS REFERENCE TO RELATED APPLICATION

This claims priority to European Patent Application No. EP 16154992.8, filed Feb. 10, 2016, which is hereby incorporated by reference herein in its entirety for all purposes.

### FIELD

The invention lies in the field of the automated in vitro diagnostic systems. The subject matter of the invention relates to a method for transferring sample liquids in an automated analysis machine.

### BACKGROUND

These days, a number of detection and analysis methods for determining physiological parameters in body fluid samples or other biological samples are performed in an automated manner and in large numbers in automated analysis machines, also so-called in vitro diagnostic systems.

Current analysis machines are able to perform a multiplicity of detection reactions and analyses using a sample. In order to be able to perform a multiplicity of examinations in an automated manner, various apparatuses for the spatial transfer of measurement cells, reaction containers and reagent containers are required, such as, e.g., transfer arms with a gripper function, transport belts or rotatable transport wheels, and apparatuses for transferring liquids, such as, e.g., pipetting apparatuses. The machines comprise a control unit, which, by means of appropriate software, is able to plan and process the work steps for the desired analyses largely independently.

Many of the analysis methods used in such analysis machines with automated operation are based on optical processes. These methods facilitate the qualitative and quantitative detection of analytes, i.e., the substances in samples to be detected or determined. The determination of clinically relevant parameters, such as, e.g., the concentration or activity of an analyte, is often implemented by virtue of part of a sample being mixed with one or more test reagents in a reaction vessel, which may also be the measurement cell, as a result of which, e.g., a biochemical reaction or a specific binding reaction is initiated, bringing about a measurable change in an optical or other physical property of the test mix.

Automatically operating analyzers, which are used to examine biological bodily fluids, fill the required reagents with a pipetting needle into a measurement cuvette by means of a pipetting apparatus. Here, the measurement cuvette is automatically displaced by means of a robotic arm to various positions within the automated analysis machine by means of a cuvette gripper, with said robotic arm being part of a robotic station. After the measurement, the used measurement cuvette is brought through a waste shoot into a waste container, for example for disposal purposes.

A multiplicity of different machine assemblies for processing the sample is required in an automated analyzer for processing an analysis of a sample. By way of example, some of the sample liquid of a sample introduced into a primary vessel is transferred into an aliquot vessel with the aid of a pipetting apparatus. This process is also referred to as taking an aliquot, i.e., taking a portion. The primary vessel may promptly leave the analyzer again and the remaining sample liquid may be forwarded to further analyzers. There, further analyses of the sample may then be prompted and carried out parallel in time. Then, for the purposes of analyzing the sample, parts of, or the entire sample liquid is taken from the aliquot vessel and processed further on the analyzer.

Taking an aliquot offers various advantages, including the option of an unchanging high speed of the sample input into an analyzer, independently of which analyses are intended to be carried out on the analyzer and/or the number of the analyses provided on the analyzer for a sample.

However, taking an aliquot is not possible for all samples. By way of example, in pediatric samples, in particular, there often is only so little sample liquid available that it is not possible to aliquot. Likewise, it is not possible to aliquot in the case of specific control measurements, in which certain sample-like control materials are analyzed. In these cases, taking an aliquot and the pipetting into the aliquot vessel are dispensed with.

On account of the system liquid which is situated in the pipetting needle of the pipetting apparatus of the analyzer, the sample liquid mixes with the system liquid in each instance of pipetting a sample liquid and hence there is a dilution of the sample liquid with system liquid. As a result of this, there is slightly less sample material in a given volume of sample liquid after a pipetting process than in the same given volume of sample liquid prior to the pipetting process. As a result, results of analyses which are carried out with or without aliquoting may deviate from one another and may not be comparable to one another since the amounts of an analyte contained in a given sample volume may deviate from one another. This is not desirable and may be highly relevant and very problematic, for example in the case of therapy decisions in neonatology.

### SUMMARY

It is therefore an object of the invention to make available a method for processing a sample in an automated analysis machine and a corresponding analysis machine, which facilitate a comparison of analysis results of analyses, independently of whether the analyses were carried out with aliquoting or without aliquoting.

According to the invention, this object is achieved by the subjects and methods described below.

The invention proceeds from the concept of facilitating a comparison of analysis results, independently of whether the analyses were carried out with aliquoting or without aliquoting by virtue of the dilution effects, which arise in analyses where there is aliquoting on account of the additional pipetting process, being able to be achieved in analyses without aliquoting by virtue of adapting the pipetted volume from the primary vessel.

It was found that an improved comparability of analysis results in an automated analysis machine may be reached by virtue of the pipetted volume from the primary vessel being reduced in analyses without aliquoting in a manner dependent on a volume-dependent correction factor and a volume-independent correction factor. This is advantageous in that a particularly accurate correction of the dilution effects may be carried out and results of analyses which were carried out with or without aliquoting are comparable in a very detailed manner.

The subject matter of the present invention is a method for transferring a first sample liquid from a first primary vessel into a first target vessel and a second sample liquid from a second primary vessel into a second target vessel with the aid of at least one automated pipetting apparatus comprising a system liquid in an automated analysis machine comprising a control machine, said method comprising the following steps:

a) receiving a first liquid volume V1 of the first sample liquid with the aid of the pipetting apparatus from the first primary vessel,

b) dispensing the first liquid volume V1 of the first sample liquid with the aid of the pipetting apparatus into an aliquot vessel,

c) receiving a second liquid volume V2 of the first sample liquid with the aid of the pipetting apparatus from the aliquot vessel,

d) dispensing the second liquid volume V2 of the first sample liquid with the aid of the pipetting apparatus into the first target vessel,

e) receiving a third liquid volume V3 of the second sample liquid with the aid of the pipetting apparatus from the second primary vessel,

f) dispensing the third liquid volume V3 of the second sample liquid with the aid of the pipetting apparatus into the second target vessel,

wherein the third liquid volume V3 of the second sample liquid is automatically ascertained with the aid of the control machine in accordance with the following relationship:

V3=k1V2+k2,

where V2 denotes the second liquid volume of the first sample liquid, k1 denotes a predetermined liquid-volume-dependent correction factor and k2 denotes a predetermined liquid-volume-independent correction factor and where the correction factor k1 is unequal to one.

This is advantageous in that the different ways of processing with taking an aliquot and without taking an aliquot supply comparable results and a comparison of analyses which is independent of their respective way of being processed is facilitated. By way of example, the method according to the invention allows the amount of an analyte, which remains in the pipetting apparatus when taking an aliquot in an additional pipetting process and which does not arrive in the first target vessel, to be taken into account accurately and to be accordingly taken into account and corrected in a processing way without taking an aliquot.

By way of example, the correction factors k1 and k2 may be ascertained in comparative measurement series with different processing ways and effects of a reduced or increased amount of the analyte on the measurement results may be determined. Since the occurring effects do not necessarily depend linearly on the amount, or the difference in amount, of the analyte, it may be necessary to carry out measurement series over the entire range in which possible results may lie.

The correction factor k1 corrects a mixing of sample liquid and system liquid during a pipetting process. By way of example, this occurs in the interior of a pipetting needle of the pipetting apparatus and may, for example, depend on the pipetted volume of the sample liquid and the used system liquid.

The correction factor k2 corrects a spread of the sample liquid on the outside of the pipetting needle. This is independent of the pipetted volume of the sample liquid, but may, for example, depend on the immersion depth of the pipetting needle into the sample liquid and on the material of the pipetting needle.

Furthermore, the correction factors k1 and k2 may, for example, depend on the temperature of the sample liquid, the pipetting needle and/or the system liquid.

Preferably, the pipetting apparatus comprises at least one pipetting needle.

In a preferred embodiment of the method, the correction factor k1 and the correction factor k2 are predetermined in such a way that the third liquid volume V3 of the second sample liquid is less than the second liquid volume V2 of the first sample liquid.

In a further preferred embodiment of the method, the correction factor k1 is less than one and greater than zero.

In a further preferred embodiment of the method, the correction factor k2 is unequal to zero.

In a further preferred embodiment of the method, the correction factor k2 is less than zero.

In a further preferred embodiment of the method, the correction factor k2 corresponds to a volume of the first sample liquid adhering to the outside of a pipetting needle of the pipetting apparatus.

In a further preferred embodiment of the method, the correction factor k1 and/or the correction factor k2 are determined experimentally for the pipetting apparatus. Preferably, the experimental determination is carried out using an automated analyzer. This is advantageous in that the correction may be ascertained precisely for the respective pipetting apparatus.

In a further preferred embodiment of the method, the correction factor k1 and/or the correction factor k2 are determined by comparative measurement series with a different number of instances of receiving and dispensing the first liquid and the second liquid with the aid of the pipetting apparatus. This is advantageous in that the correction may be ascertained specifically for the processing ways occurring in the respective analyzer, with different numbers of pipetting processes.

In a further preferred embodiment of the method, the system liquid is water. This is advantageous in that the system liquid is largely harmless from a toxicological point of view and, in this respect, it is possible to preclude any danger to persons operating the analyzer. Furthermore, water is available with high purity in a comparatively simple manner.

In a further preferred embodiment of the method, the first sample liquid and/or the second sample liquid contain a sample of a patient, a calibrator, a control material and/or a control solution.

In a further preferred embodiment of the method, the first sample liquid and/or the second sample liquid contains a bodily fluid, preferably blood or urine.

Further subject matter of the invention relates to an automated analysis machine comprising at least one automated pipetting apparatus comprising a system liquid for transferring liquid volumes and at least one control machine, wherein the control machine is configured in such a way that it may control the execution of a method for transferring a first sample liquid from a first primary vessel into a first target vessel and a second sample liquid from a second primary vessel into a second target vessel according to one of the methods according to the invention.

In a preferred embodiment of the automated analysis machine, the automated pipetting apparatus is fastened to a robotically displaceable or robotically swivelable transfer arm. This is advantageous in that the pipetting processes at various positions within the analyzer may be carried out automatically by the automated pipetting apparatus.

In a further preferred embodiment of the automated analysis machine, it comprises a multiplicity of receiving positions for respectively one primary vessel, aliquot vessel and/or target vessel, and/or a multiplicity of automated pipetting apparatuses with robotically displaceable and/or robotically swivelable transfer arms. This is advantageous in that a multiplicity of samples and analyses may be processed simultaneously on the analyzer and the throughput time for the analyses may be reduced and hence the sample throughput may be increased.

An automated analysis machine comprises a multiplicity of machine assemblies in a preferred embodiment. By way of example, the machine assemblies are an, e.g., disk-shaped transport and bearing device for sample vessels, an, e.g., disk-shaped transport and bearing device for reagent containers, an incubation block, a photometer, or another assembly of the automated analysis machine which is required for processing samples.

In a further preferred embodiment, the sample is situated in a non-stationary cuvette and at least one, preferably at least two machine assemblies are configured as receiving positions for the cuvette. This is advantageous in that a multiplicity of samples and analyses may be processed in a particularly flexible manner.

Within the meaning of the invention, a “sample” should be understood to mean the material which presumably contains the substance to be detected (the analyte). In particular, the term “sample liquid” comprises biological liquids of humans or animals, such as, e.g., blood, plasma, serum, sputum, exudate, bronchoalveolar lavage, lymph fluid, synovial fluid, semen, vaginal mucus, feces, urine, liquor, or else, e.g., tissue or cell culture samples prepared accordingly for photometric, preferably nephelometric determination by homogenization or cell lysis. Furthermore, plant liquids or tissues, forensic samples, water and sewage samples, foodstuff, or pharmaceuticals may also serve as a sample which, possibly, should be subject to an appropriate sample pretreatment prior to the determination.

Quantitative detection involves measuring the amount, the concentration or the activity of the analyte in the sample. The expression “quantitative detection” also covers semi-quantitative methods, which can detect only the approximate amount, concentration or activity of the analyte in the sample or can serve only to provide a relative indication of amount, concentration or activity. Qualitative detection should be understood as the detection of the actual presence of the analyte in the sample, or the indication that the amount, concentration or activity of the analyte in the sample is below or above a defined threshold value or several defined threshold values.

By way of example, the first target vessel and/or second target vessel is a measurement cell in each case, preferably a measurement cuvette in each case.

By way of example, a measurement cuvette is a cuvette or reaction vessel made of glass, plastic or metal. Advantageously, the measurement cuvette is manufactured from optically transparent materials which may be advantageous, particularly when using optical analysis methods. The terms “measurement cuvette” and “cuvette” are used synonymously.

The first primary vessel and/or second primary vessel is, for example, a blood sample tube in each case.

By way of example, the aliquot vessel is a vessel made of glass, plastic or metal. Preferably, the aliquot vessel is, e.g., a measurement cell or measurement cuvette.

### BRIEF DESCRIPTION OF THE DRAWINGS

The invention is explained in more detail in an exemplary manner on the basis of the drawings. In the drawings:

FIG. 1 shows a schematic illustration of the pipetting processes (11, 12) with aliquoting between a first primary vessel (1), an aliquot vessel (2), and a first target vessel (3), and

FIG. 2 shows a schematic illustration of the pipetting process (13) without aliquoting between a second primary vessel (4) and a second target vessel (5).

The same parts have been provided with the same reference signs in all figures.

### DETAILED DESCRIPTION

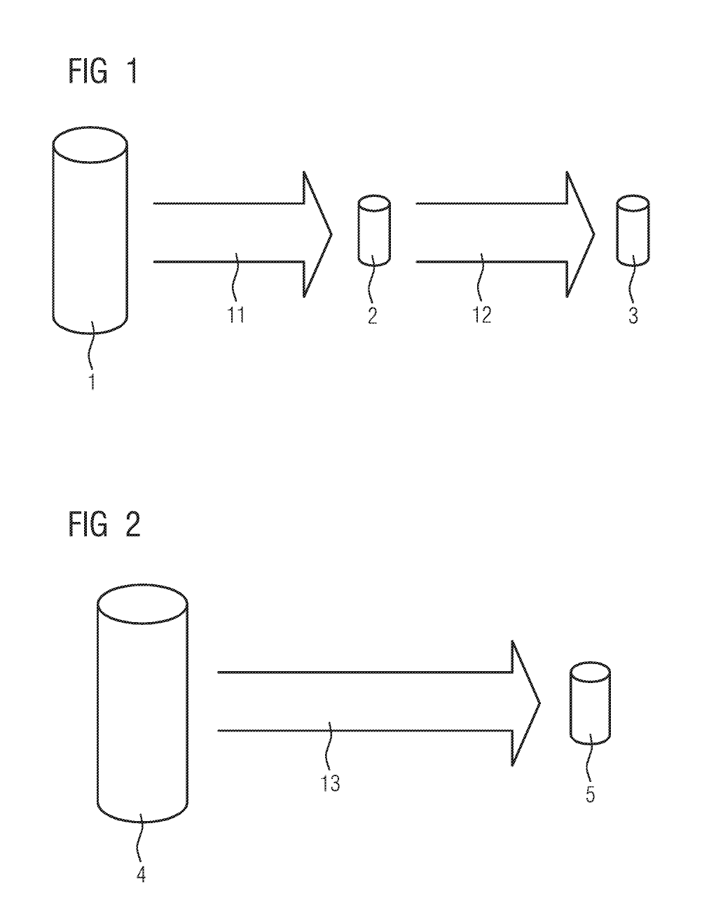

The vessels (1, 2, 3, 4, 5) in accordance with FIG. 1 and FIG. 2 are situated in an automated analysis machine not depicted in any more detail, the latter being configured to process a sample and comprising a control unit with a computer system for controlling the processing of the sample, and a multiplicity of machine assemblies for processing the sample, such as, e.g., pipetting apparatuses and transport devices.

FIG. 1 schematically shows an illustration of pipetting processes (11, 12) with aliquoting between a first primary vessel (1), an aliquot vessel (2) and a first target vessel (3). For the pipetting process (11) between the first primary vessel (1) and the aliquot vessel (2), the pipetting apparatus takes a first liquid volume V1 of the first sample liquid from the first primary vessel (1) and dispenses the first liquid volume V1 again into the aliquot vessel (2). The first liquid volume V1 is 300.0 microliters (μl).

In the pipetting apparatus there is an inadvertent mixture and dilution of the first sample liquid with system liquid by approximately 3 percent (%). The system liquid is water. At the outset, the first sample liquid contains 300.0 units of an analyte in 300.0 μl of sample liquid in the first primary vessel (1). After the pipetting process (11), 300.0 μl of sample liquid in the aliquot vessel (2) only still contain 291.0 units of the analyte and 9.0 μl of the system liquid on account of the dilution.

For the pipetting process (12) between the aliquot vessel (2) and the first target vessel (3), the pipetting apparatus takes a second liquid volume V2 of the first sample liquid from the aliquot vessel (2) and dispenses the second liquid volume V2 again into the first target vessel (3). The second liquid volume V2 is 50.0 μl.

Analogous to the pipetting process (11) between the first primary vessel (1) and the aliquot vessel (2), there once again is inadvertent mixing and dilution of the first sample liquid with the system liquid by approximately 3% in the pipetting apparatus. The first sample liquid originally contains 291.0 units of the analyte in 300.0 μl of sample liquid in the aliquot vessel (2) and 9.0 μl of system liquid. After the pipetting process (12), 50.0 μl of sample liquid in the first target vessel (3) only still contain 47.0 units of the analyte and 3.0 μl of system liquid on account of the renewed dilution.

FIG. 2 schematically shows an illustration of a pipetting process (13) without aliquoting between a second primary vessel (4) and a second target vessel (5). For the pipetting process (13), the pipetting apparatus takes a third liquid volume V3 of a second sample liquid from the second primary vessel (4) and dispenses the third sample volume V3 again into the second target vessel (5). The first sample liquid and the second sample liquid are the same, and therefore the analyses of the first sample liquid and the second sample liquid should supply comparable results. The third liquid volume V3 is 48.5 μl. The third liquid volume V3 is ascertained in accordance with the following relationship in the case of the given second liquid volume V2:

V3=k1V2+k2,

where k1 denotes a predetermined liquid-volume-dependent correction factor and k2 denotes a predetermined liquid-volume-independent correction factor.

The correction factor k1 emerges from the degree of dilution of the sample liquids during the pipetting process (11) from the first primary vessel (1) into the aliquot vessel (2). This dilution is 3%. Hence, the correction factor k1 emerges as k1=0.97 with the relationship 100%−3%=97%.

The correction factor k2 is zero.

Hence, the third volume V3=48.5 μl emerges in the case of a second volume V2 of 50 μl.

There is inadvertent mixing and dilution of the second sample liquid with the system liquid by 3% in the pipetting apparatus during the pipetting process (13). The system liquid is water. Originally, the second sample liquid contains 48.5 units of an analyte in 48.5 μl of sample liquid in the second primary vessel (4). After the pipetting process (13), 48.5 μl of sample liquid in the second target vessel (5) still contain 47.0 units of the analyte and 1.5 μl of system liquid on account of the dilution.

Hence, the sample liquids in the first target vessel (3) and second target vessel (5) contain the same amount of the analyte. This facilitates the ability of obtaining comparable results in subsequent analyses of the sample liquid in the first target vessel (3) and second target vessel (5).

In the case of a non-inventive method with V3=V2=50 μl, 48.5 units of the analyte would be situated in the second target vessel (5). However, there would only be 47.0 units of the analyte in the first target vessel (3) in an unchanged manner. Hence, the subsequent analyses of the sample liquid in the first target vessel (3) and second target vessel (5) would obtain results that deviate from one another and are not comparable to one another, even though the first sample liquid in the first primary vessel (1) and the second sample liquid in the second primary vessel (5) both in each case contained 50.0 units of the analyte in 50.0 μl of sample liquid.

### LIST OF REFERENCES

1 First primary vessel

2 Aliquot vessel

3 First target vessel

4 Second primary vessel

11, 12, 13 Second target vessel

What is claimed is:

1. A method for transferring a first sample liquid from a first primary vessel into a first target vessel and a second sample liquid from a second primary vessel into a second target vessel using at least one automated pipetting apparatus comprising a system liquid in an automated analysis machine comprising a control machine, the method comprising:
receiving a first liquid volume V1 of the first sample liquid using the pipetting apparatus from the first primary vessel,
dispensing the first liquid volume V1 of the first sample liquid using the pipetting apparatus into an aliquot vessel,
receiving a second liquid volume V2 of the first sample liquid using the pipetting apparatus from the aliquot vessel,
dispensing the second liquid volume V2 of the first sample liquid using the pipetting apparatus into the first target vessel,
receiving a third liquid volume V3 of the second sample liquid using the pipetting apparatus from the second primary vessel, and
dispensing the third liquid volume V3 of the second sample liquid using the pipetting apparatus into the second target vessel,
wherein the third liquid volume V3 of the second sample liquid is automatically ascertained using the control machine in accordance with the following relationship:
V3=k1V2+k2,
where V2 denotes the second liquid volume of the first sample liquid, k1 denotes a predetermined liquid-volume-dependent correction factor, k2 denotes a predetermined liquid-volume-independent correction factor, and the correction factor k1 is unequal to one.

2. The method as claimed in claim 1, wherein the correction factor k1 and the correction factor k2 are predetermined such that the third liquid volume V3 of the second sample liquid is less than the second liquid volume V2 of the first sample liquid.

3. The method as claimed in claim 1, wherein the correction factor k1 is less than one and greater than zero.

4. The method as claimed in claim 1, wherein the correction factor k2 is unequal to zero.

5. The method as claimed in claim 1, wherein the correction factor k2 is less than zero.

6. The method as claimed in claim 1, wherein the correction factor k2 corresponds to a volume of the first sample liquid adhering to an outside of a pipetting needle of the pipetting apparatus.

7. The method as claimed in claim 1, wherein the correction factor k1 or the correction factor k2 was determined experimentally for the pipetting apparatus.

8. The method as claimed in claim 7, wherein the correction factor k1 or the correction factor k2 was determined by a comparative measurement series with a different number of instances of receiving and dispensing the first sample liquid and the second sample liquid using the pipetting apparatus.

9. The method as claimed in claim 1, wherein the system liquid is water.

10. The method as claimed in claim 1, wherein the first sample liquid or the second sample liquid contains a sample of a patient, a calibrator, a control material, or a control solution.

11. The method as claimed in claim 1, wherein the first sample liquid or the second sample liquid contains a bodily fluid.

12. The method as claimed in claim 12, wherein the bodily fluid is blood or urine.

13. An automated analysis machine comprising at least one automated pipetting apparatus comprising a system liquid for transferring liquid volumes and at least one control machine,
wherein the control machine is configured to control the execution of the method as claimed in claim 1.

14. The automated analysis machine as claimed in claim 13, wherein the automated pipetting apparatus is fastened to a robotically displaceable or robotically swivelable transfer arm.

15. The automated analysis machine as claimed in claim 13, wherein the automated analysis machine comprises a multiplicity of receiving positions for respectively one primary vessel, aliquot vessel or target vessel, or a multiplicity of automated pipetting apparatuses with robotically displaceable or robotically swivelable transfer arms.
